(19) United States
(12) Patent Application Publication
(10) Pub. No.: US 2014/0260593 A1
(43) Pub. Date: Sep. 18, 2014

(54) SYSTEM FOR ACQUIRING AND REPORTING AIR FLOW CONDITIONS

(71) Applicant: Jay LEBOFF, Bedford, NY (US)

(72) Inventor: Jay LEBOFF, Bedford, NY (US)

(21) Appl. No.: 13/800,600

(22) Filed: Mar. 13, 2013

(51) Int. Cl. G01P 13/02

(52) U.S. Cl. CPC G01P 13/02
USPC 73/170.01

(57) ABSTRACT

A sensor system that includes a sensor module and a display module, in which the sensor module includes a streamer rotatable about a rotation axis in response to air flow, and the display device is configured to report the status of the streamer in a human perceptible form.

### FIELD OF THE INVENTION

The present invention relates to electronic devices that sense and report air flow, and in particular a system that reports air flow conditions.

### BACKGROUND OF THE INVENTION

A telltale is a piece of yarn or fabric attached to the jib or the main sail of a sailboat. Telltales are typically used in pairs one on the port side and another on the starboard side of the main sail or the jib.

It is known that based on the behavior of a telltale a sailor can make proper adjustments to the sail position.

Determining qualitatively whether the sail is in the proper position based on subjective observation of the behavior of telltales can be difficult. Thus, it is desirable to have an objective way of determining air flow conditions particularly for sailing.

### SUMMARY OF THE INVENTION

An objective of the present invention is to simplify the determination of the proper position of a sail based on the behavior of a streamer flowing in the wind.

A sensor system according to the present invention includes a sensor module, which detects and reports air flow conditions to a display module.

The sensor module in its preferred form includes a sensor assembly having a rotatable support that is rotatable about a rotation axis, a streamer attached to and extending radially from the rotatable support, and a sensor device that generates an output indicative of the position of the rotatable support relative to a reference position.

Preferably, the streamer may be an elongated body having a longitudinal axis that is transverse to the rotation axis or a compliant body, which when stretched, will have a longitudinal axis that is transverse to the rotation axis.

Preferably, the rotatable support is rotatable relative to a cylindrical hub and the rotation axis of the rotatable support coincides with the central axis of the hub.

The display module is configured to receive information indicative of the position from the sensor module and to report, in a human perceptible form, the displacement status of the streamer in response to the air flow based on the position. The status reported may indicate that the rotatable support/the streamer is outside a predesignated angular range, or the status may be the actual angular displacement of the rotatable support/the streamer relative to a reference position, which may be designated as the zero angular position.

The sensor module and the display module may be wirelessly connected, whereby, at the very least, the sensor module can send information to the display module and the display module can receive information from the sensor module wirelessly.

The sensor assembly in the sensor module may be configured as an optical encoder and thus may include at least one optical sensor element, e.g. a photodiode. The assembly may include a light source as is well known to those familiar with optical encoders.

Alternatively, the sensor module may include a non-optical sensor capable of detecting angular displacements, for example, a hall effect sensor.

In a system according to the present invention, the display module includes a microprocessor which is programmed to operate a display device in response to the information received from the sensor module. For example, the microprocessor may determine, based on the information received from the sensor module, that the streamer is angularly displaced so that it is outside a predesignated range (which may be stored in an electronic memory location within the microprocessor) and operate a visual indicator such as an LED to apprise the user of that status.

Alternatively, the microprocessor is programmed to determine the actual angular displacement of the streamer relative to a reference position and operate a visual indicator such as an LCD to report the actual displacement value to the user.

In one embodiment, the sensor module may be rendered affixable to a surface. For example, the sensor module may be provided with an adhesive or a clip so that it may be mounted to a location (e.g. a sail) on a vessel.

Other features and advantages of the present invention will become apparent from the following description of the invention, which refers to the accompanying drawings.

### BRIEF DESCRIPTION OF THE DRAWINGS

FIG. 1 schematically illustrates a system according to the present invention.

FIG. 2A shows a top perspective view of a sensor module of a system according to the present invention.

FIG. 2B shows a top perspective view of a sensor module of a system according to the present invention with the top, the streamer, and the rotatable support thereof removed from view.

FIG. 2C shows an indexed pattern residing on the underside surface of the rotatable support of the sensor module in a system according to the present invention.

FIG. 3A is a top perspective view of a display module in a system according to the present invention according to a first embodiment.

FIG. 3B shows a top perspective view of components of a display module residing on a common circuit board.

FIG. 3C shows a top perspective view of a display module in a system according to the second embodiment of the present invention.

### DETAILED DESCRIPTION

Referring to FIG. 1, a system according to the present invention includes a sensor module 10 and a display module 12. Sensor module 10 and display module 12 are preferably packaged separately and are configured to be in wireless communication when in their ON state. Specifically, at the very least, sensor module 10 is configured to send data to display module 12 wirelessly and display module 12 is configured to receive data from sensor module 10 wirelessly.

Sensor module 10 includes a sensor device 14 in communication with a sensor circuit 16. Sensor circuit 16 receives the output of sensor device 14 and, after any necessary formatting and processing, relays the output of sensor device 14 to wireless transmitter 18.

Sensor module 10 further includes, preferably, a rechargeable battery 20, which receives power from a charger circuit 22. In the preferred embodiment, charger circuit 22 receives electrical power from one or more solar devices 24 and regulates the power so received for the proper charging of rechargeable battery 20.

Sensor device 14, sensor circuit 16, and wireless transmitter 18 receive power from battery 20. While not shown, sensor module 10 may be equipped with an ON/OFF switch, which may be used to save battery power, for example, at night when solar device(s) 24 are not receiving solar energy.

Display device 12 includes a wireless receiver 26, which is in wireless communication with wireless transmitter 18 when sensor module 10 and display module 12 are in an ON state. Wireless receiver 26 is in communication with a microprocessor 28 that is programmed to interpret data received from transmitter 18 and operate a display device 30 based on the data so received. Specifically, microprocessor 28 is in communication with a display driver 29, which drives display device 30. Microprocessor 28 operates display driver 29, which in turn operates display device 30 in order to visually report information regarding the condition of air flow at or near sensor module 10 to a human user as further disclosed below.

Display module 12 further includes a rechargeable battery 32, which is charged by a charger circuit 34. Charger circuit 34 may receive power from power supply contacts configured for connection to an external power source, for example, a battery on board the vessel (e.g. the sail boat). Display module 12 may further include an ON/OFF manual switch 36 that can interrupt power to wireless receiver 26, microprocessor 28, display driver 29 and display device 30. Battery 32 supplies power to wireless receiver 26, microprocessor 28, display driver 29 and display device 30 when switch 36 is in its ON state.

In an alternative embodiment, ON/OFF switch 36 turns display module 12 and any sensor module(s) 10 in communication with display module from an ON state to an OFF state and vice versa. Thus, in this embodiment, the ON/OFF state of a sensor module 10 is controlled from module 12 and may not require a separate ON/OFF switch.

Referring now to FIGS. 2A, 2B and 2C, a sensor module 10 according to the present invention includes a streamer 38 which is coupled at one of its ends to a rotatable support 40 and extends in a radial direction relative to support 40 to terminate at an opposite end. The opposite end of streamer 38 is free and able to move in response to the air flow (i.e. wind).

Streamer 38 is preferably an elongated plastic body or the like that is light enough so that it may move in response to air flow. Streamer 38 may be a rigid elongated body having a longitudinal axis along its length or it may be a compliant body that could be stretched out (e.g. in response to air flow) to become an elongated body having a longitudinal axis aligned along its length. Streamer 38 could also be a piece of fabric or yarn much like an ordinary telltale.

Rotatable support 40 is rotatably supported by a cylindrical hub 42. For example, rotatable support 40 includes a circular hole which snaps onto cylindrical hub 42 allowing support 40 to rotate relative to hub 42, while preventing support 40 to disengage from hub 42. Rotatable support 40 rotates about an axis of rotation that coincides with the longitudinal, central axis of hub 42 thus enabling the rotation of streamer 38 about the longitudinal axis of hub 42, whereby streamer 38 can align its longitudinal axis with the direction of air flow. Preferably, the longitudinal axis of streamer 38 and the rotation axis of support 40 are orthogonal to one another.

In the configuration shown in FIG. 2A, sensor module 10 includes a housing having a top 44 and a base 46. Top 44 includes a port 48 through which battery 20 is accessible. Port 48 is closed off with a top 50, which may be screwed in, or snapped into port 48. Solar device(s) 24, which may be photovoltaic devices (or a coating of a photovoltaic material), are arranged on the exterior surface of top 44 and preferably occupy whatever area not occupied by port 48 and rotatable support 40.

Referring now to FIG. 2B (which depicts a sensor module 10 without top 44, rotatable support 40, and streamer 38) in its preferred form, sensor module 10 includes a common circuit board 52 that supports battery 20, charger circuit 22, wireless transmitter 18, sensor circuit 16, and sensor device 14. Circuit board 52 preferably resides inside base 46 and includes all conductive traces necessary to make the appropriate electrical connection between the components of sensor module 10.

In the preferred embodiment, sensor device 14 includes a sensor element that produces an electrical output in response to receiving light. For example, the sensor element may be a photodiode. Sensor device 14 may include at least one sensor element (e.g. one photodiode), but may include more than one sensor element (more than one photodiode). Thus, sensor device 14 should not be understood to be restricted to a single device.

Top 44 is provided with an opening above sensor 14. As illustrated in FIG. 2C, on the underside surface (i.e. surface directly facing sensor device 14) of rotatable support 40 an indexed pattern 54 is provided, which is readable by sensor device 14. Pattern 54 may be printed on the underside surface of rotatable support 40, or a body having pattern 54 printed thereon may be installed on the underside surface of support 40. Angular orientation of the longitudinal axis of streamer 38 can be determined based on rotation of rotatable support 40 (caused by movement of streamer 38), which causes pattern 54 to move over sensor device 14. Specifically, the output of sensor device 14 is formatted by sensor circuit 16 and relayed, via wireless transmitter 18 to wireless receiver 26. Wireless receiver 26 relays the data received from wireless transmitter 18 to microprocessor 28. Microprocessor 28 is programmed to interpret the data received and operates display driver 29, which in turn drives a display device 30 to visually apprise the user of the angular orientation of streamer 38 which indicates the direction of air flow.

In the preferred embodiment, sensor device 14, rotatable support 40 having pattern 54, and hub 42 realize a sensor assembly that is configured and operated as an absolute optical encoder. As is well known in the art, in an absolute, optical encoder, a pattern can be configured to be indicative of the angular position of the encoder's shaft. In this case however, hub 42 is stationary while support 40 rotates in response to movement of streamer 38. In the preferred embodiment, pattern 54 can be devised to be indicative of the angular position of rotatable support 40 about its rotation axis (which coincides with the central longitudinal axis of hub 42), which in turn indicates the angular position of the longitudinal axis of streamer 38 since steamer 38 is arranged so that its longitudinal axis is transverse (preferably orthogonal) to the rotation axis of rotatable support 40. Digital or analogue configurations may be devised without deviating from the scope of the present invention. In a digital configuration, each section of pattern 54 is configured to produce a digital code indicative of the angular position of support 40 relative to a reference angular position. The reference angular position may be designated to be at 0°, and the angular orientation of rotatable hub 40 will be reported in relation to the reference angular position of 0°.

For example, in a configuration in which sensor device 14 includes two sensor elements (i.e. two photosensitive diodes), a first section of pattern 54 can result in the first sensor element sending an ON signal and the second sensor element sending an OFF signal, indicating that support 40 is within 0° to −10° relative to the reference position (0°), a second section of pattern 54 can result in the first sensor element sending an OFF signal and the second sensor element sending an ON signal, indicating that support 40 is within 0° to +10° relative to a reference position (0°), a third section of pattern 54 can result in the first sensor element sending an ON signal and the second sensor element sending an ON signal, indicating that support 40 is more than −10° away from a reference position (0°), and a fourth section of pattern 54 can result in the first sensor element sending an OFF signal and the second sensor element sending an OFF signal, indicating that support 40 is more than +10° away from a reference position (0°). Other digital coding schemes may be employed without deviating from the present invention. The proper pattern to achieve the desired angular indexing is well known in the art and need not be repeated here.

The digital output indicative of the angular position of rotatable support 40 is decoded by microprocessor 28 when a digital configuration is employed. Thus, microprocessor 28 would be programmed to decode the output of sensor device 14 as received from sensor module 10.

Sensor circuit 16 formats and sends its output of the sensor element(s) to wireless transmitter 18, which is then sent to wireless receiver 26. By format, it is meant, the output of sensor device 14 is transformed into a form capable of being received and interpreted by a microprocessor. For example, when the output of sensor device 14 is comprised of voltage pulses, the pulses are transformed into digital code (encoded).

Microprocessor 28 is programmed to interpret the data received from wireless receiver 26 in order to determine the angular position of support 40 and operates display driver 29 to drive display device 30 in order to report whether support 40 is outside a predetermined angular range as further explained below.

It should be noted that while not specified above, a light source may be provided to irradiate pattern 54, and the reflected light from that light source may be captured by sensor device 14.

Referring now to FIGS. 3A and 3B, display module 12 includes a plurality of visual indicators 56, which comprise display device 30. Visual indicators 56 may be, for example, LEDs and are arranged at a top surface of the housing of display module 52. Each indicator 56 reports the angular orientation of a respective support 40 associated with a streamer 38 of a respective sensor module 10.

According to one embodiment of the present invention, when microprocessor 28 determines, based on data received from sensor module 10, that support 40 is angularly displaced outside of a designated range, an indicator 56 is operated (e.g. an LED is lit). For example, microprocessor 28 may be programmed to instruct display circuit 29 to operate an indicator 56 associated with a particular sensor module 10, when support 40 of that particular module is angularly displaced±10° from its reference position (e.g. the 0° position). The reference position may be, for example, a position at which streamer 38 is longitudinally aligned with the horizon.

The designated range may be recorded in an electronic memory location associated with microprocessor 28 and may be unchangeable by the user. Alternatively, the designated range may be recorded in the electronic memory by the user.

Microprocessor 28 will compare the designated range to the position data received from sensor module 10 to determine whether to operate the display device 30 or not.

In the preferred embodiment, display module 12 includes a plurality of visual indicators 56 each for reporting data of a respective sensor module 10 located on a particular position in the vessel. For example, a sensor module 10 may be provided at each of the following locations: port side of the jib (indicators 56 in column 62), starboard side of the jib (indicators 56 in column 64), port side of the sail (indicators 56 in column 66) and starboard side of the sail (indicators in column 68).

Referring to FIG. 3B, in the preferred embodiment, a common circuit board 58 (which resides inside the housing of display module 12) supports and provides the necessary conductive traces for the connection of battery 32 to wireless transmitter 26, microprocessor 28, display driver 29 and display device 30.

Furthermore, in the preferred embodiment, circuit board 58 supports power input contacts 60. Power input contacts 60 are connected via appropriate conductive traces on circuit board 58 to charger circuit 34 and are configured to receive power from an external power source (e.g. a battery on board the vessel).

Referring to FIG. 3C, in a system according to the second embodiment of the present invention, visual indicators 56 may be LCD displays. In this embodiment, microprocessor 28 may operate indicators 56 to display the actual angular position of streamer 38 relative to a reference position, e.g. a direction parallel to the horizon. For example, microprocessor 28 may report that a streamer 40 of a sensor module 10 is +5° displaced from the horizon. As is the case with the display module of FIG. 3A, the display module shown in FIG. 3C reports conditions from sensor modules 10 located at different locations in the vessel, which are identified with the same numerals for illustrative purposes. A display module 12 can be configured to report angular positions up to 360° relative to a reference position (i.e. a designated 0° position).

A sensor module 10 according to the present invention may be configured with a sensor other than an optical sensor. For example, a hall effect sensor may be used without deviating from the scope of the present invention. Sensor module 10 may be equipped with circuitry that turns sensor module 10 OFF when streamer 38 is not moving.

Display module 12 may be equipped with circuitry that turns display module 12 OFF when no signals are received from a sensor module 10. In a preferred embodiment, battery 32 is used only as a backup power, and power is primarily supplied from a battery on board the vessel via connectors 60.

Each sensor module 10 may be provided with an adhesive or the like so that it can be affixed to a surface. A sensor module 10 could also include a clip or the like so that it may be affixed to a sail or a stay. For example, the adhesive or the clip may be provided on the back surface of base 46 of sensor module 10.

A system according to the preset invention can be used to trim a sail, monitor air flow on an air craft or monitor air flow on an object in a wind tunnel.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A sensor system comprising:
a sensor module that includes a sensor assembly having a streamer that is rotatable about a rotation axis, and a sensor device that generates an output indicative of position of said streamer relative to a reference position; and
a display module that is configured to receive information indicative of said position from said sensor module and to report, in a human perceptible form, a status based on said position.

2. A sensor system according to claim 1, wherein said display module is configured to receive said information of said position wirelessly.

3. A sensor system according to claim 1, wherein said sensor assembly is an optical encoder.

4. A sensor system according to claim 1, wherein said status indicates that said streamer is out of a predesignated angular range.

5. A sensor system according to claim 1, wherein said status is indicative of an angular position of said streamer relative to a reference position.

6. A sensor system according to claim 1, wherein said sensor module includes solar devices disposed on an exterior surface thereof.

7. A sensor system according to claim 1, wherein said display module includes a microprocessor programmed to operate a display driver, which drives a display device to indicate said status in visual form.

8. A sensor system according to claim 7, wherein said status indicates that said streamer is out of a predesignated angular range.

9. A sensor system according to claim 7, wherein said status is indicative of an angular position of said streamer relative to said reference position.

10. A sensor system according to claim 7, wherein said display device includes at least one LED which is driven to indicate said status in visual form.

11. A sensor system according to claim 1, wherein said sensor module is affixable to a surface.

12. A sensor system according to claim 1, wherein said streamer is an elongated body having a longitudinal axis that is transverse to said rotation axis.

13. A sensor system according to claim 1, wherein said streamer is a compliant, elongated body that, when in a stretched state, includes a longitudinal axis that is transverse to said rotation axis.

14. A sensor system according to claim 1, further comprising a rotatable support, said streamer being attached to and radially extending from said rotatable support, wherein said rotatable support is rotatable relative to a hub.

15. A sensor system according to claim 14, wherein said rotation axis is the central axis of said hub.

16. A sensor system according to claim 1, wherein said sensor module includes a sensor device.

17. A sensor system according to claim 16, wherein said sensor device includes at least one sensor element.

18. A sensor system according to claim 17, wherein said sensor element is a photodiode.

19. A sensor system according to claim 16, wherein said sensor device comprises a hall effect sensor.

20. A sensor system according to claim 1, wherein said display module controls said sensor module's ON/OFF state.
